(19) United States
(12) Patent Application Publication
(10) Pub. No.: US 2024/0232473 A9
(43) Pub. Date: Jul. 11, 2024

(54) EVALUATION OF ANY PREDETERMINABLE COLLISIONS BETWEEN ANY SITES ON THE BODIES OF LIVING BEINGS AND OBJECTS OF ANY SHAPE

(71) Applicant: Fraunhofer-Gesellschaft zur Förderung der angewandten Forschung e.V., München (DE)

(72) Inventor: Roland BEHRENS, Magdeburg (DE)

(21) Appl. No.: 18/568,015

(22) PCT Filed: Jun. 10, 2022
(86) PCT No.: PCT/EP2022/065903

§ 371 Date: Dec. 7, 2023

(30) Foreign Application Priority Data
Jun. 10, 2021 (DE) 10 2021 205 876.0

(51) Int. Cl. G06F 30/20; B25J 9/16

(52) U.S. Cl. CPC G06F 30/20; B25J 9/1666

(57) ABSTRACT

The invention relates to evaluating a predetermined collision between a predetermined site (2) on the body of a living being and a predetermined object (1), comprising the steps of a) providing a 3D model of the predetermined object (1) on an arithmetic logic unit; b) providing a polygon mesh model of the predetermined site (2) on the body on an arithmetic logic unit, wherein each field Fij of the mesh of the polygon mesh model is square, and a stress-deformation characteristic curve (s) is predetermined for each field Fij of the mesh; c) aligning the provided 3D model and the provided polygon mesh model in a virtual space by means of the arithmetic logic unit, wherein the arrangement of the two models relative to one another corresponds to the relative arrangement of the object and the site on the body during the predetermined collision; d) gradually shifting the 3D model and the polygon mesh model into one another in a collision direction (K) determined by the predetermined collision, in the virtual space, by means of the arithmetic logic unit, wherein an impression image (AB) having impression pixels Pij is generated for each step k of the gradual shifting process and a respective pixel value Pw of the impression pixels Pij represents an impression depth of the 3D model in a field Fij of the mesh of the polygon mesh model that is assigned to the respective impression pixel Pij; e) determining the respective stress values for the impression pixels Pij for the or at least one of the impression images (AB, AB′, AB″) according to the stress-deformation characteristic curve (s) assigned to the corresponding field Fij and the respective pixel value Pw; f) calculating a force F acting on the predetermined site (2) on the body by adding up the products of the stress values determined for the impression pixels Pij with the surface areas Aij of the assigned fields Fij of the mesh, for the step k corresponding to the at least one impression image (AB, AB′, AB″); in order to rapidly and accurately evaluate any predeterminable collisions between sites on the bodies of living beings and any objects, in particular with regard to a risk of injury to an operator, for example.

The invention relates to a method for evaluating any predetermined collision, in particular with regard to a risk of injury, between any predetermined site on the body of a living being and any predetermined object. In particular, the living being can be a human and/or the object can be a robot apparatus, for example a collaborative robot. The invention also relates to a corresponding collision evaluation device for predetermining limit speeds which prevent the robot apparatuses from being able to cause injury in the event of a collision with a living being, for example a human. The method and the device can also be called and understood as a method and a device for iteratively determining safe robot speeds.

When an object, for example a robot, collides with a living being, for example a human, there is deformation of the skin and the underlying tissue at the affected site on the body of the living being. The deformation or penetration depth is associated with a reaction force with which the tissue counteracts the impacting object. If the reaction force or the deformation exceeds a certain threshold, serious injuries can occur. For industrial robot apparatuses which move around in the environment around humans without additional protective measures, known as collaborative robots (or “cobots”), ISO 10218 and ISO/TS 15066 stipulate biomechanical limit values which prevent injuries from occurring in the event of collisions with the robot.

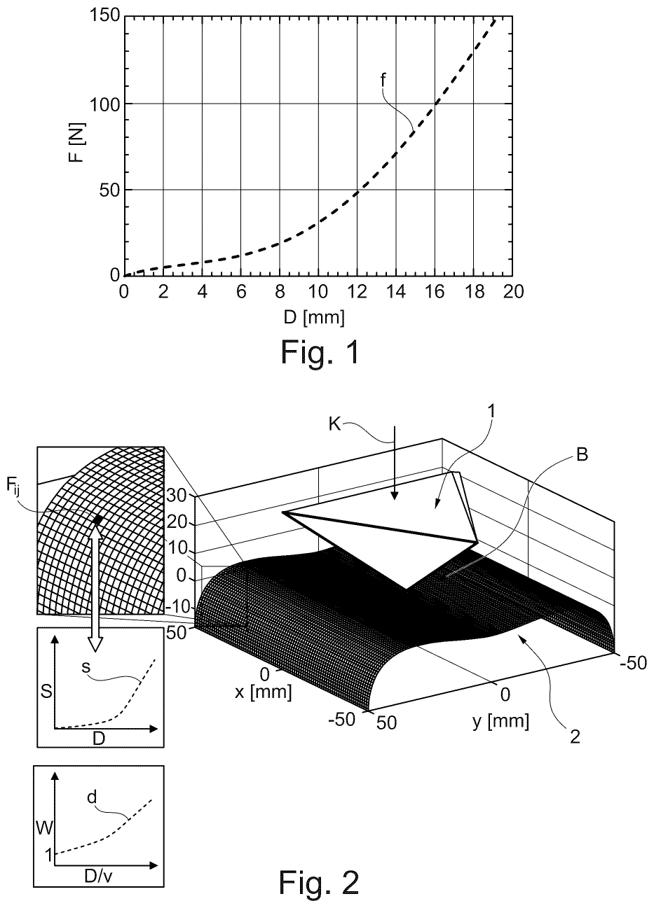

The biomechanical relationship between the reaction force and deformation range is highly non-linear owing to the hyperelastic and viscous behavior of human, animal, or plant tissue. The progression of a force-deformation characteristic curve which describes the biomechanical response of the tissue is similar to an exponential function that assumes an almost linear gradient above a certain threshold value. This is shown by an exemplary progression in FIG. 1. The specific progression of a force-deformation characteristic curve that is relevant to a predetermined collision is decisively dependent on the site on the body involved and the shape of the impacting object and its impact speed.

To evaluate a risk of injury on a robot, the decisive force-deformation characteristic curve plays a key role. If the characteristic curve for the site on the body involved and the contact point on the robot is known, the course of a collision can be determined on the basis of the characteristic curve and a robot model and the maximum contact forces together with the associated maximum deformations can be calculated on the basis of physical parameters of the robot and the speed of the robot. Accordingly, it can be shown that a relevant risk of injury arises from the (simulated) collision if the calculated contact forces exceed the biomechanical limit values applicable to the robot in question. Alternatively, a safe speed which the object, in the present case, the robot apparatus, may not exceed for the point in time in question can be iteratively calculated in order to prevent the limit values from being exceeded at this point in time by a collision with a living being and to thus prevent a living being from being injured.

The model-based risk evaluation is of particular interest for collaborative robotics, since, owing to the varied movements of the robot, a large number of contact situations can arise with the potential to pose a hazard to humans. Up to now, owing to the large number of options for different contact situations, just one measurement method has been available for checking the safety of collaborative robots. Owing to high costs and technical limitations, however, the measurement method goes against these robots being widely introduced in industry and other fields, such as the care sector.

In the prior art, a predetermined collision can be evaluated by means of finite element methods (FEM), wherein an associated force-deformation characteristic curve is determined by numerical calculation. The computational effort when using the FEM with corresponding tissue deformation models and contact models is, however, very high, which is why this method is not suitable for being integrated in the control of robot apparatuses, since, for evaluating collisions in realistic scenarios, it is necessary to calculate the required characteristic curves within a short time, and in any case in under one minute, in order to adjust, on that basis, the speed of the robot or other safety-relevant parameters that then prevent injury in the event of a collision.

This therefore poses the problem of rapidly and accurately evaluating any predeterminable collisions between sites on the bodies of living beings and any objects and, on the basis of an evaluation result, of automatically and preferably directly making settings on the robot, such as the robot speed, which reduces the risk of injury to an operator, for example, and preferably reduces it to a permissible level.

This problem is solved by the subject matter of the independent claims. Advantageous embodiments are set out in the dependent claims, the description, and the drawings.

One aspect relates to a method for evaluating (suitable for the automatic and/or real-time-capable regulation of a robot apparatus) a (any) predetermined collision, in particular with regard to a risk of injury, between a (any) predetermined site on the body of a living being and a (any) predetermined object. The living being can be a human and/or an animal and/or a plant. The object is preferably an object that is hard in comparison with the site on the body in question, i.e. that does not deform during the collision. For example, the object can be a (any) predetermined part of a robot apparatus, i.e. a robot. The collision can involve an impact and/or said object getting jammed. In this case, the method comprises a series of method steps.

One method step is that of providing a geometric volume model of the predetermined object which impacts the site on the body in question. This model can be in a file format that is standard for 3D models and is provided on an arithmetic logic unit. Another method step is that of providing a geometric polygon mesh model of the predetermined site on the body on an arithmetic logic unit. The geometric polygon mesh model of the site on the body in question can also be called a body part model. In this case, the shell or envelope of the polygon mesh model is similar to that in the FEM of a three-dimensional mesh structure, wherein each field Fij of the associated mesh of the polygon mesh model is square. Accordingly, by means of indices i, j, each field of the mesh is or can be uniquely determined as a two-dimensional submanifold of the three-dimensional space. Preferably, all the square fields have the same edge lengths, such that the indices, known as matrices, can specify columns and rows of the mesh.

In this case, a stress-deformation characteristic curve is predetermined for each field Fij of the mesh. The stress-deformation characteristic curve can also be predetermined in modified form, for example as an area-adjusted stress-deformation characteristic curve in the form of a respective force-deformation characteristic curve. As a result, the multiplication of the determined stress values, as mentioned again below, is favored, and thus ascertains respective force values for the impression pixels Pij in accordance with the respectively assigned force-deformation characteristic curve and the respective pixel value Pw. Since the commutative law is applicable to the multiplication, the use of a stress-deformation characteristic curve with subsequent multiplication by the respective areas is equivalent to using the area-adjusted stress-deformation characteristic curve in the form of a respective force-deformation characteristic curve. Therefore, the term “stress values” in the method step of capturing, as described below, also covers “force values”, which correspond to the product of the stress value together with the areas from the method step of calculating the acting force. The described method steps therefore do not need to be carried out in the order that is predetermined (in the claims), even though this is possible.

The square basic shape of the fields or mesh elements Fij means that the 3D or volume model can only be curved about one axis. Accordingly, non-square mesh structures do not work with the proposed method. In this case, the edge length of the mesh elements has a significant influence on the accuracy of the model, i.e. the shorter the edge length, the more accurately the predetermined collision can be quantified and evaluated. For example, the edge length can be less than 2 mm or less than 1 mm or less than 0.5 mm. The stress-deformation characteristic curve for the individual square mesh elements Fij can be stored in a database in this case. The stress-deformation characteristic curve reflects the strain behavior of the finite area on the site on the body, which is represented by the square mesh element or field Fij. It can be determined by tests on test subjects or FEM analyses, for example.

The provided 3D model and the provided polygon mesh model are then aligned in a virtual space by means of the arithmetic logic unit. In this case, the arrangement of the two models relative to one another corresponds to the relative arrangement of the object and the site on the body during the predetermined collision. Advantageously, the alignment is carried out such that, after the alignment, the distance of the two models from one another at at least one contact point of the two models, i.e. at one or more contact points of the two models, the point at which the object and the site on the body touch for the first time in the collision, is zero.

After this method step, the 3D model and the polygon mesh model are gradually shifted into one another in a collision direction determined by the predetermined collision, in the virtual space, by means of the arithmetic logic unit. Preferably, this takes place up to an expected maximum deformation range. For example, the impacting object is shifted in discrete steps that are in particular as small as possible, such that it geometrically penetrates the three-dimensional mesh model of the site on the body. This shifting can accordingly take place iteratively, but just one single shifting step can also be carried out. After each shifting step, an impression image having respective impression pixels Pij is generated for each (iterative) step k of the gradual shifting process. A respective pixel value w of the impression pixels Pij represents an impression depth of the 3D model in a field Fij of the mesh of the polygon mesh model that is assigned to the respective impression pixel Pij. If the impression image is filtered, weighted, or otherwise processed as described below, the first-generated or originally generated impression image is also referred to as the “original impression image”, and the further processed impression image is referred to as the “filtered impression image”. In the same way as the surface of the site on the body, i.e. the shell, the impression image is therefore a two-dimensional image. Therefore, for each shifting step, (exactly) one two-dimensional impression image is available, the pixels of which indicate, by way of the indices i, j, at which points the impacting object deforms the body model, and, by way of the assigned pixel values Pw, the extent to which the body model is deformed at these points. The gradual shifting of the object in the virtual space can be repeated (iterated) until a preset maximum shifting distance is reached. In this case, the impression depth and thus the pixel value Pw can be determined in different ways, and one exemplary embodiment is explained below.

Another method step is that of determining the respective stress values for the impression pixels Pij, ideally only for the impression pixels Pij having an entry that is different from zero, for the or at least one of the impression images, preferably the impression images according to the stress-deformation characteristic curve assigned to the corresponding field Fij and the respective pixel value Pw. Practically speaking, the fields Fij and impression pixels Pij having the identical indices i, j can be assigned to one another. This considerably simplifies the computing steps and is possible because, according to the method, the view is effectively reduced to two dimensions.

Lastly, a force Fₖ acting on the predetermined site on the body is calculated by adding up the products of the stress values determined for the impression pixels with the surface areas Aij of the assigned fields Fij of the mesh, for step k corresponding to the at least one impression image, preferably for many or all of the impression images corresponding to the steps k. This can be expressed by the formula Fₖ=Σ_{i,j} σ(Pijₖ)×Aij. Here, σ(Pijₖ) denotes the stress predetermined by the respective stress-deformation characteristic curve on the pixel Pij and therefore field Fij by the pixel value Pw. Lastly, the collision can be evaluated on the basis of a result of one of the preceding method steps, in particular on the basis of the acting force calculated here in step k and/or a force-deformation characteristic curve derived from the calculated acting forces and/or analogous results, for example energy derived from the force or the force-deformation characteristic curve, in particular a maximum permissible kinetic energy for the object and/or the robot.

The collision in question can then be calculated using the force-deformation characteristic curve and a physical model of the robot. The calculation is then repeated with an altered initial speed until the calculated contact force corresponds to the limit value applicable to the collision. The bisection method is preferably used as the iteration method. The initial speed calculated by iteration then corresponds to the limit speed that the robot may not exceed. After being calculated, the limit speed can be used as desired to regulate the movement speed of the robot (FIG. 1) or to parameterize a monitoring apparatus, a collision evaluation device for model-based safety evaluation of robot apparatuses (FIG. 2), which switches off the robot once it

exceeds the limit speed.

FIG. 1: speed control

FIG. 2: speed monitoring

Similarly to the FEM, the proposed method is capable of calculating biomechanical force-deformation characteristic curves or equivalent quantifications of a collision. By contrast with the FEM, the presented method allows for considerably reduced computing times for the quantified evaluation of a collision, for example to calculate force-deformation characteristic curves for further processing steps or even just individual limit values for forces or energy that occur. This is explained further in the following. Owing to its efficiency, it is suitable in particular for the model-based, i.e. quantified, evaluation of risks that originate from collisions and pinching that occurs when humans are working together with collaborative robots.

The presented method accordingly allows a collision evaluation device, for example for robot control, to calculate soft tissue deformation at a site on the body, as occurs upon impact with an object of any shape, within a short time. By contrast with the known approaches in the finite element methods, the proposed method uses a geometric shell model, which is implemented by a mesh, which is shaped as regularly as possible, made up of square area elements. Only by using square mesh elements and thus by way of a limitation to one-dimensional curvatures for the body part is it possible to transfer the model surface to a two-dimensional image with low computational effort. When the shell model is deformed by a three-dimensional object, the deformed points can be represented as pixels in the two-dimensional impression image, wherein each pixel value corresponds to the deformation value at the associated point on the shell model, which in turn indicates the shift in the associated mesh element relative to the initial state. Since each mesh element is linked to a specific, thus preferably individual, stress-deformation characteristic curve, a contact force can be calculated from the deformation values indicated by the pixels, and specifically can be resolved in accordance with the discrete steps of the deformation. This contact force alone can be used for evaluating the collision. In combination with the position of the robot, the calculated force then corresponds to a point in the force-deformation characteristic curve sought for the downstream calculation. By repeatedly applying the method, the entire characteristic curve can thus be calculated for each position step of the robot, which corresponds to the gradual shifting of the object in the virtual space, and can then be used for the further evaluation of the collision with the aid of a physical robot model.

The method can also comprise g) compiling a force-deformation characteristic curve by mapping the forces calculated from method step f) (calculating a force F acting on the predetermined site on the body) to the discrete shifting path used in method step d) (gradually shifting the 3D model and the polygon mesh model into one another), and h) evaluating the collision using the force-deformation characteristic curve and a physical model of the object, in particular the robot apparatus, while varying the initial speed of the object, in particular the robot apparatus, by means of the bisection method until the initial speed of the object results in a collision force that corresponds to the limit value applicable to this collision, and i) transferring the calculated initial speed to the robot control for adjusting or monitoring the robot speed, and preferably adjusting and/or monitoring the robot speed according to the transferred initial speed.

Accordingly, in an advantageous embodiment, it is provided to determine the respective stress values for the impression pixels Pij for a plurality of impression images, in particular all the impression images, and to calculate the force F acting on the predetermined site on the body for a plurality of steps k, in particular for all steps k, corresponding to the respective impression images, and to generate a force-deformation characteristic curve for the predetermined collision of the predetermined object with the predetermined site on the body based on the determined forces. Preferably, the collision can also be evaluated on the basis of the generated force-deformation characteristic curve, preferably by predetermining a maximum permissible, i.e. predetermined, energy and/or maximum permissible deformation and/or maximum permissible force for a movement of the object underlying the collision. The evaluation can provide, as an evaluation result, a limit for a speed, in particular for a robot speed, which may not be exceeded by the object or robot. Accordingly, as part of the method, the robot apparatus can be controlled or monitored on the basis of the evaluation result, i.e. the limit for the speed. The energy transferred from the object to the site on the body that then may not exceed the maximum permissible energy is specified by an integral of the force-deformation characteristic curve from zero up to a corresponding deformation (distance) value. If the collision is evaluated by predetermining the maximum permissible deformation, it is not necessary to generate and use the force-deformation characteristic curve.

In another advantageous embodiment, it is provided that, before determining the respective stress values for the impression pixels Pij, the generated (original) impression image(s) is/are filtered. This filtering can in particular be carried out using at least one image-based filter known from image processing and/or using filtering based on machine learning methods. Accordingly, the respective stress values are then determined and the acting force or forces are calculated on the basis of the filtered impression image, i.e. the pixel values Pw of the filtered impression image(s).

Filtering has the advantage that deformations of mesh elements or fields that adjoin the fields that are actually deformed by direct contact with the object can be taken into account. It has been found that even relatively simple filters, such as a blurring filter, effectively represent or emulate the environment around the fields on the surface of the body that are deformed by direct contact. Owing to the filters, a more realistic deformation pattern can thus arise, as would happen in reality when an object acts on a body part in the collision in question. With the geometry of the polygon mesh model and suitably selected parameters of the filters, in particular the image-based filters, it is possible here to effectively emulate the natural deformation pattern in the filtered impression image. The corresponding parameters for the selected filter can be determined empirically in this case.

The filtering thus has the aim of smoothing the previously obtained impression images, such that the smoothed impression images, which are then transferred back to the shell model, reproduce the realistic, smoothly extending deformation pattern on the skin, as would typically arise in humans in the contact zone in question. Each pixel value in the filtered impression images thus corresponds to a realistic shift in the associated mesh element Fij, which is why the transfer back to the shell model results in realistic three-dimensional mapping of the skin deformation.

For example, the filtering can be carried out in two steps. In this embodiment, in a first step, each individual pixel is then filtered in a separate filtering process before, in a second step, the results of the separate filtering processes are combined and the filtered impression image is generated. In the present case, for each pixel to be filtered, i.e. for each pixel having a pixel value Pw that is different from zero, a copy of the associated impression image is first generated within a shifting step k, and the pixel values Pw of all the other pixels Pij are set to zero in the copy of the impression image. A corresponding filter, for example a blurring filter, is then applied to the respective remaining pixel having a pixel value Pw that is different from zero in the respective copies of the impression image. Here, the influence of the adjacent surface of the body is thus emulated by the contact point selected in each case in the form of the pixel having a pixel value Pw that is different from zero. Lastly, a filtered impression image is generated from the copies of the impression image to which the filter has been applied, i.e. the filtered copies. For this purpose, the highest value Pw which occurs for all the pixels Pij assigned to the same field Fij in all the copies of the impression image to which the filter has been applied is selected as the value Pw of each pixel Pij of the filtered impression image. In the second step of filtering, the value Pw of each pixel Pij in the filtered impression image is compared with the value Pw of the corresponding pixel in the original impression image, and the value Pw of the respective pixel in the filtered impression image is set to zero if the two values differ from one another by more than a predetermined tolerance value, and the value Pw is left if the two values differ from one another by the tolerance value or less than the predetermined tolerance value, i.e. are identical or substantially identical. This filtered impression image is then used in the subsequent steps instead of the original impression image.

In filter stage 1, in the present case, each individual pixel value in the impression image is thus smoothed in a separate filtering process. Since the copying and/or filtering process is carried out for all the pixels in the impression image having a value>0, for n pixels of which the value is >0, n copies or n filtered impression images which contain the filtering result of the individual filtered pixels are also present. Subsequently, the pixel at the position i, j having the highest pixel value is transferred into the filtered impression image from all n filtered impression images, i.e. the intermediate images. If the value of the pixel Pij in the filtered impression image then corresponds to the value of the Pij in the original impression image, it is assumed that the impacting object is actually touching the site on the human's body at this point. At the points at which it does not touch, the associated pixels in the filtered impression image do not fulfil the condition, which is why the pixels in the resulting image have the value 0.

The described filtering thus has the advantage that the collision is quantified more accurately and, in particular, the forces that occur are prevented from being overestimated. As a result, for example, an accordingly controlled robot apparatus can be operated at higher operating speeds and can nevertheless be safe.

In another advantageous embodiment, it is provided that an additional factor matrix image having pixel values Vij is generated by edge detection being performed on the original impression image, wherein the additional factor matrix image is adjusted such that it has a pixel value>1 at edge positions and has a pixel value=1 at non-edge positions. This can for example be carried out by the value 1 being added to each pixel value in a resulting image of the edge detection. When determining the respective stress values for the impression pixels Pij or, in a mathematically equivalent manner, when calculating the force F acting on the predetermined sites on the body, i.e. before evaluating the collision, the determined stress values for the impression pixels are multiplied by the respectively assigned pixel values Vij of the additional factor matrix image. Accordingly, the force calculated for a step k can thus be specified by the formula Fₖ=Σ_{i,j} Vijₖ×σ(Pijₖ)×Aij.

This has the advantage that localization effects of objects having hard edges are taken into account, since increased mechanical stresses typically act on the body part at edges. Therefore, the mechanical stresses determined in the remaining method steps can be subsequently increased in the edge region and a more realistic evaluation can be generated.

In another advantageous embodiment, it is provided that a further factor matrix image having pixel values Wij is generated and the determined stress values for the impression pixels Pij are multiplied by the respectively assigned pixel values Wij of the further factor matrix image before the collision is evaluated. In particular, the further factor matrix image is generated by a respective strain rate, the impression pixels Pij and thus the assigned field Fij, being determined on the basis of the value Pw of the impression pixel Pij respectively assigned to the pixel value Wij and a collision speed predetermined for the collision, and the pixel value Wij being determined on the basis of the respective strain rate by means of a strain rate characteristic curve predetermined for the field Fij assigned to the respective impression pixel Pij. The values of the strain rate characteristic curve and thus the pixel values Wij are >=1 here. In this case, like the additional factor matrix image, the further factor matrix image is individually predetermined for one, several, or all the steps k in each case. The strain rate characteristic curves of the field Fij can be identical or individually predetermined for each field Fij or group of fields Fij. Accordingly, the force calculated for a step k can thus be specified by the formula Fₖ=Σ_{i,j} Wijₖ×σ(Pijₖ)×Aij or, if the further factor matrix image is applied so as to be combined with the additional factor matrix image, by the formula Fₖ=Σ_{i,j} Wijₖ×Vijₖ×σ(Pijₖ)×Aij.

This has the advantage that the strain rate dependency of the sensitivity of biological tissue is replicated, i.e. the dependency of the risk of injury on the penetration speed of the impacting object, and thus the collision is evaluated more accurately using the further factor matrix that is dependent on the collision speed.

In another advantageous embodiment, it is provided that the respective impression depth, the pixel value Pw of a pixel Pij of the impression image assigned to a field Fij, is calculated by a straight line being placed through the midpoint of the respective field Fij in parallel with the normal vector, and it is determined whether or not the straight line meets the surface of the object, and if yes, the distance between the point of intersection of the straight line and the surface of the object and the midpoint of the respective field Fij is determined as the impression depth if the distance corresponds to the object penetrating the living being; for example, in a suitable definition, the distance is <0. A suitable definition of this kind is, for example, selecting the normal vector such that it points outward in relation to the body part. In a reverse definition of the directions, however, a positive distance can, for example, also correspond to the object penetrating the living being. This definition of the impression depth has been found to be advantageous in the sense of the computational effort and the accuracy of the results that can be obtained.

In another advantageous embodiment, it is provided that the edges of each field Fij of the mesh are the same length or are a natural multiple of the same length. The size of each field is therefore a natural multiple of a unit size, but does not have to be the same.

One aspect also relates to a method for controlling a robot apparatus in which a collision is preferably calculated using the force-deformation characteristic curve. The force-deformation characteristic curve has been previously determined using the method according to any of the embodiments described above. The result of the calculation is then used to control or monitor the robot apparatus, i.e. the robot apparatus is controlled on the basis of an evaluation result of the method.

Another aspect relates to a collision evaluation device, which is configured to align a provided 3D model of a predetermined object and a provided polygon mesh model of a predetermined site on the body in a virtual space, wherein the arrangement of the two models relative to one another corresponds to the relative arrangement of the object and the site on the body during a predetermined collision, and wherein each field Fij of the mesh of the polygon mesh model is square, and a stress-deformation characteristic curve is predetermined for each field Fij of the mesh. The collision evaluation device is also configured to gradually shift the 3D model and the polygon mesh model into one another in a collision direction determined by the predetermined collision, in the virtual space, where an impression image having impression pixels Pij is generated for each step k of the gradual shifting process and a respective pixel value Pw of the impression pixels Pij represents an impression depth of the 3D model in a field Fij of the mesh of the polygon mesh model that is assigned to the respective impression pixel Pij. In this case, exactly one field Fij is preferably assigned to each impression pixel Pij, and vice versa. The gradual shifting process corresponds to the movement of the object, for example of the robot apparatus, at the collision point in question. The movement is provided as a starting condition and thus determines the collision direction and/or the collision speed. The movement of the object can in particular change with the action of the increasing contact force. The change in the movement with the (contact) force calculated by the above-described method or the above-described device can be, but does not have to be, taken into account in the method or device in iterative form.

Furthermore, the collision evaluation device is also configured to determine the respective stress values for the impression pixels Pij for the or at least one of the impression images, in particular the impression images, according to the stress-deformation characteristic curve assigned to the corresponding field Fij and the respective pixel value Pw, and calculating at least one force F acting on the predetermined site on the body by adding up the products of the stress values determined for the impression pixels Pij with the surface areas Aij of the assigned fields Fij of the mesh, for step k corresponding to the at least one impression image.

Yet another aspect also relates to a robot apparatus comprising a collision evaluation device of this kind and/or a controller for a robot apparatus which comprises a collision evaluation device of this kind and is configured to control the robot apparatus on the basis of an evaluation result, in particular on the basis of the calculated force acting on the predetermined site on the body and/or on the basis of the maximum permissible energy and/or on the basis of the maximum permissible deformation and/or on the basis of the maximum permissible force.

Here, advantages and advantageous embodiments of the collision evaluation device correspond to advantages and advantageous embodiments of the above-described method, and vice versa.

The features and feature combinations set out above in the description, and also in the introductory part, as well as the features and feature combinations set out below in the description of the figures and/or shown only in the drawings can be used not only in the combination stated, but also in other combinations, without departing from the scope of the invention. Embodiments of the invention can thus also be considered to be included and disclosed which are not explicitly shown and explained in the drawings, but follow from and can be produced from the explained embodiments by way of separate combinations of features. Embodiments and combinations of features can also be considered to be disclosed which thus do not comprise all the features of an originally formulated independent claim. In addition, the invention should be deemed to disclose embodiments and feature combinations, in particular those resulting from the above-described embodiments, that either go beyond or deviate from the feature combinations set forth in the back-references of the claims.

The subject matter according to the invention will be explained in greater detail with reference to the following figures, without restricting it to the specific embodiments set out here.

In the drawings:

FIG. 1 shows an exemplary force-deformation characteristic curve;

FIG. 2 shows an exemplary situation for a 3D model of an object and a polygon mesh model of a predetermined site on the body, which model is aligned in a virtual space according to a collision;

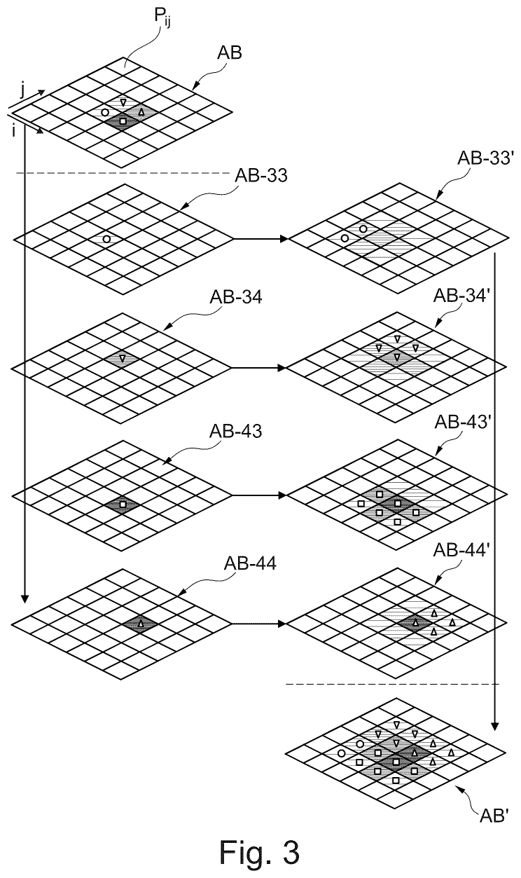

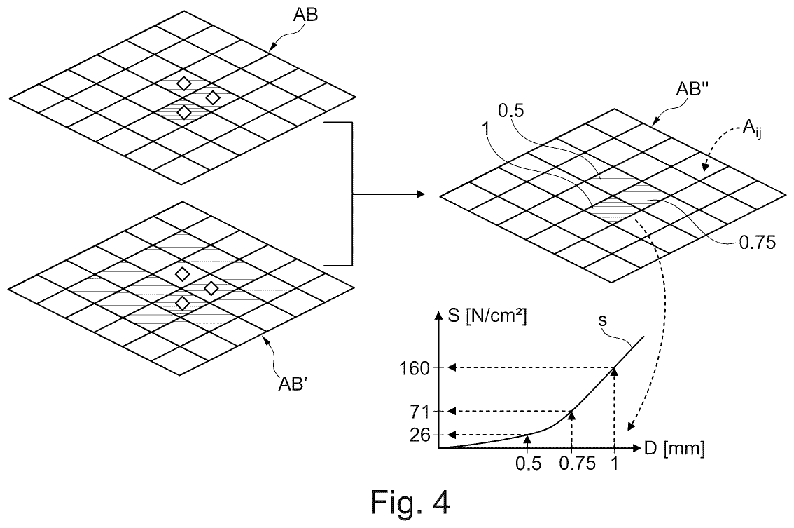

FIG. 3 and FIG. 4 show exemplary steps of filtering an impression image.

In the drawings, identical and functionally identical elements are provided with identical reference signs.

FIG. 1 shows an exemplary progression of a force-deformation characteristic curve f, determined in the present case for the forearm muscle when acting upon a cylinder having a diameter of 25 mm. The applied force F is plotted in this figure in Newtons against the deformation D of the tissue in millimeters. It is typical that the force-deformation characteristic curve F progresses exponentially, and therefore linearly, up to a limit value, in the present case, a deformation of around 13 mm.

FIG. 2 shows an exemplary arrangement of a 3D model of an object and a polygon mesh model of a predetermined site on the body. In the present case, the object 1 is represented by a pyramidal 3D model of which a tip contacts a predetermined site 2 on the body, represented by a (planar) polygon mesh model, at a touching point B. The site 2 on the body is a palm in the example shown. The polygon mesh model comprises, in its mesh, a large number of fields Fij, which are square and are also identical in size in the present case. During the collision, the object 1 moves into the site 2 on the body in the collision direction K.

Here, each field Fij is assigned a stress-deformation characteristic curve s, which assigns a respective stress s to a predetermined deformation D. In the example shown, a strain rate characteristic curve d is additionally assigned for each field, which curve assigns a value W to a predetermined strain rate D/v. In this case, D denotes the deformation and v denotes the speed at which the deformation D takes place. The strain rate can also be predetermined in a different way, for example as ε′=d/dt L(t)/L₀, where L₀ is the initial length of the material and L(t) is the length at the point in time t. The characteristic curves of course have to be predetermined in a consistent manner in line with the predetermined strain rate. By way of the strain rate characteristic curve, a strain rate dependency of the sensitivity of biological tissue can be replicated as a factor matrix image.

FIG. 3 shows a first step of exemplary filtering of a generated impression image. An impression image AB having 6×6 pixels Pij in the present case has, by way of example, four pixels Pij having values Pw that are different from zero. In the example shown, these are the four pixels P33 “◯”, P34 “∇”, P43 “□”, and P44 “Δ”. In this case, each of the four pixels has individual shading, which represents the respective pixel value Pw, wherein darker shading corresponds to a higher pixel value Pw and thus to greater deformation.

In the first step of filtering, each of the individual pixels Pij, in this case the pixels P33, P34, P43, and P44, is filtered in a separate filtering process. A corresponding copy AB-33, AB-34, AB-43, AB-44 of the associated impression image AB is generated for each pixel P33, P34, P43, and P44 to be filtered, in which image the pixel values of all the other pixels Pij are set to zero. In the respective copies AB-33, AB-34, AB-43, AB-44, a corresponding filter, in the present case a blurring filter, is applied to the remaining pixels Pij having the value Pw that differs from zero. A filtered impression image AB′ is generated from the filtered copies AB-33′, AB-34′, AB-43′, AB-44′ by the highest value Pw which occurs for all the pixels Pij assigned to the same field Fij, i.e., in the present case, all the pixels Pij having the identical indices i, j, in all the filtered copies AB-33′, AB-34′, AB-43′, AB-44′ for the pixels Pij having identical indices i, j, being selected as the value Pw of each pixel Pij of the filtered impression image AB′. Therefore, for the pixels Pij which are assigned to the same field Fij across the different filtered copies, the global maximum of the pixel value Pw is determined and only this global maximum is taken into further consideration for the corresponding pixels Pij. These maxima are each designated by “◯”, “∇”, “□”, and “Δ” in the copies AB-33′, AB-34′, AB-43′, AB-44′.

In the example shown, the filtered impression image AB′ thus contains the pixel values Pw from the copy AB-33′ for the pixels P22, P23, the pixel values Pw from the copy AB-34′ for the pixels P24, P25, P34, P35, the pixel values Pw from the copy AB-43′ for the pixels P32, P33, P42, P43, P52, P53, and the pixel values Pw from the copy AB-44′ for the pixels P44, P45, P54, P55.

FIG. 4 then shows the second step of the exemplary filtering. In this case, the pixel value Pw of each pixel Pij in the filtered impression image AB′ is compared with the value Pw of the corresponding pixel Pij in the original impression image AB in order to obtain a final filtered impression image AB″. Accordingly, the filtered impression image AB′ from the first step can be referred to as the intermediate impression image and the filtered impression image AB″ from the second step can be referred to as the resulting impression image.

For the resulting impression image AB″, the value Pw of the respective pixel Pij in the filtered impression image AB′ is set to zero if it deviates from the value PW of the respective pixel in the original impression image AB by more than a predetermined tolerance value, and the value Pw is left if the two values differ from one another by the tolerance value or less than the predetermined tolerance value. The pixels of which the pixel values Pw in impression image AB and impression image AB′ deviate from one another by the tolerance value or less than the predetermined tolerance value, i.e. are substantially identical, are designated in FIG. 4 by a diamond “⋄”. Only at these pixels Pij, in this case the pixels P34, P43, P44 or the assigned fields Fij, can the deformation actually be attributed to the direct pressure of the object on the body part, and these points are therefore decisive for evaluating the collision, in particular with regard to a risk of injury.

In the example shown, the pixels P43, P43, P44 have the pixel values 0.5, 1, and 0.75, i.e. they correspond to a deformation of 0.5 mm, 1 mm, and 0.75 mm. Since, in the present case, the pixels Pij are assigned to the area Aij=1 cm², a contact force F can be calculated by means of a stored stress-deformation characteristic curve s. In the example shown, the force of 257 N results where F=[s(0.5 mm)+s(0.75 mm)+s(1 mm)]N/cm²*1 cm²=[26+71+160]N/cm²*1 cm².

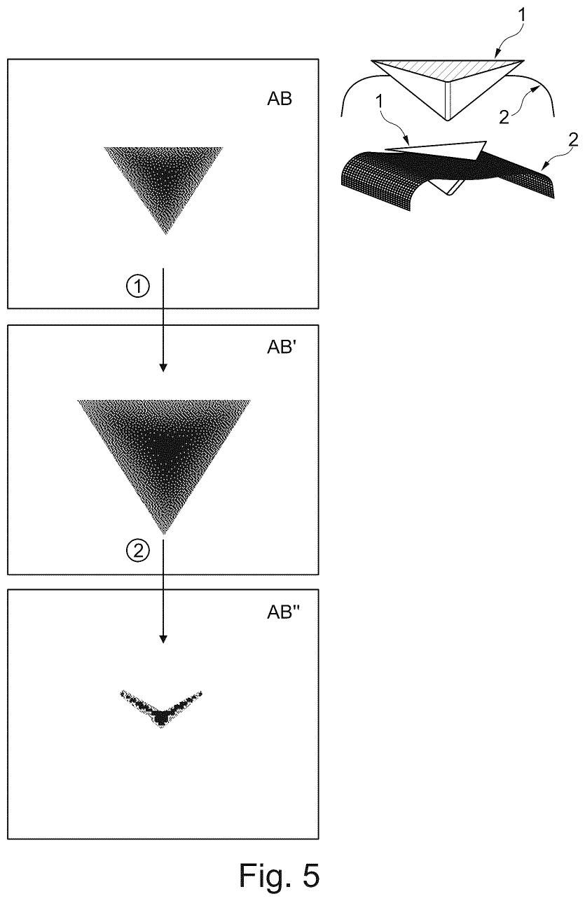

FIG. 5 shows exemplary impression images AB, AB′, AB″ for the collision also shown in FIG. 2 and a perspective view and a sectional view of the object 1 penetrating the site 2 on the body. In the impression images AB, AB′, AB″, darker shading again corresponds to greater deformation. Starting from the original impression image AB, the intermediate impression image AB′ is generated here in a first step \textcircled{1}, analogously to the first step of filtering shown in FIG. 3. The resulting impression image AB″ is accordingly generated in a second step \textcircled{2}. It is immediately, but most importantly quantifiably, clear from the resulting impression image that, when the pyramidal object collides with the palm, the deformation occurring at the edges of the object is decisive for evaluating the collision, in particular a resulting risk of injury.

1. A method for evaluating a predetermined collision between a predetermined site on a body of a living being and a predetermined object, the method comprising:
providing a three-dimensional (3D) model of the predetermined object on an arithmetic logic unit;
providing a polygon mesh model of the predetermined site on the body of the living being on the arithmetic logic unit, wherein each field Fij of the mesh of the polygon mesh model is square, and wherein a stress-deformation characteristic curve is predetermined for each field Fij of the mesh;
aligning the provided 3D model and the provided polygon mesh model in a virtual space via the arithmetic logic unit, wherein an arrangement of the provided 3D model and the provided polygon mesh model relative to one another corresponds to a relative arrangement of the predetermined object and the predetermined site on the body of the living being during the predetermined collision;
gradually shifting the 3D model and the polygon mesh model into one another in a collision direction determined by the predetermined collision, in the virtual space, using the arithmetic logic unit, wherein at least one impression image having impression pixels Pij is generated for each step k of the gradual shifting, and wherein a respective pixel value Pw of the impression pixels Pij represents an impression depth of the 3D model in each field Fij of the mesh of the polygon mesh model that is assigned to the respective impression pixel Pij;
determining one or more respective stress values for the impression pixels Pij for the at least one impression image according to the stress-deformation characteristic curve assigned to the corresponding field Fij and the respective pixel value Pw; and
calculating a force F acting on the predetermined site on the body by adding up products of the stress values determined for the impression pixels Pij with surface areas Aij of the assigned fields Fij of the polygon mesh, for the shifting step k corresponding to the at least one impression image.

2. The method according to claim 1, further comprising:
determining the respective stress values for the impression pixels Pij for a plurality of impression images;
calculating the force F acting on the predetermined site on the body of the living being for a plurality of steps k corresponding to the respective impression images;
generating a force-deformation characteristic curve for the predetermined collision of the predetermined object with the predetermined site on the body of the living being; and
evaluating the collision based at least in part on the generated force-deformation characteristic curve by predetermining a maximum permissible energy or a maximum permissible force for a movement of the object underlying the collision.

3. The method according to claim 1, wherein before determining the respective stress values for the impression pixels Pij, the generated impression image are filtered using at least one image-based filter and/or a filter based on machine learning methods, and wherein determining the one or more respective stress values and calculating the force are done based on the filtered impression image.

4. The method according to claim 3,
wherein during the filtering, in a first step, each individual pixel is filtered in a separate filtering process, in which, first, a copy of the at least one impression image is generated for each pixel to be filtered, wherein, in the copy of the at least one impression image the pixel values Pw of all the impression Pij are set to zero, then a corresponding filter is applied to a respective pixel in respective copies of the impression image and lastly a filtered impression image is generated from the respective copies of the impression image to which the filter has been applied, by the highest value Pw which occurs for all the pixels Pij assigned to the same field Fij in all the respective copies of the impression image of this pixel Pij to which the filter has been applied being selected as the value Pw of each pixel Pij of the filtered impression image, and wherein during the filtering, in a second step, the value Pw of each pixel Pij in the filtered impression image is compared with the value Pw of the corresponding pixel Pij in the at least one impression image, and the value Pw of the respective pixel in the filtered impression image is set to zero when the two values differ from one another by more than a predetermined tolerance value, and the value Pw is left when the two values differ from one another by the tolerance value or less than the predetermined tolerance value.

5. The method according to claim 4, wherein an additional factor matrix image having pixel values Vij is generated by edge detection being performed on the at least one impression image, wherein the additional factor matrix image is adjusted such that it has a pixel value of greater than one at one or more edge positions and has a pixel value of equal to one at one or more non-edge positions, and wherein the determined stress values for the impression pixels Pij are multiplied by the respectively assigned pixel values Vij of the additional factor matrix image.

6. The method according to claim 1, wherein a further factor matrix image having pixel values Wij is generated and the determined stress values for the impression pixels Pij are multiplied by the respectively assigned pixel values Wij of the further factor matrix image, wherein the further factor matrix image is generated by a respective strain rate being determined based on the value Pw of the impression pixel Pij respectively assigned to the pixel value Wij and a predetermined collision speed, and wherein the pixel value Wij is determined based on the respective strain rate using a strain rate characteristic curve predetermined for the field Fij assigned to the respective impression pixel Pij.

7. The method according to claim 1, wherein the respective impression depth is calculated by a straight line being placed through a midpoint of the respective field Fij in parallel with a normal vector, and it is determined whether or not the straight line meets a surface of the predetermined object, when the straight line meets the surface of the predetermined object, a distance between a point of intersection of the straight line and the surface of the object and the midpoint of the respective field Fij is determined as the impression depth if the distance corresponds to the object penetrating the living being.

8. The method according to claim 7, wherein after the alignment, the distance of the 3D model and the polygon mesh model from one another at, at least one contact point, of the two models is zero.

9. The method according to claim 1, wherein two or more edges of each field Fij of the mesh have an equal length or have a lengths that are a natural multiple of each other.

10. The method according to claim 1, wherein the method is used for evaluating a collision between a predetermined site on the body of a human and a predetermined part of a robot apparatus.

11. A collision evaluation device, which is configured to:
align a provided three-dimensional (3D) model of a predetermined object and a provided polygon mesh model of a predetermined site on a body in a virtual space, wherein an arrangement of the provided 3D model and the provided polygon mesh model relative to one another corresponds to relative arrangement of the predetermined object and the predetermined site on the body during a predetermined collision, and wherein each field Fij of the mesh of the polygon mesh model is square, and a stress-deformation characteristic curve is predetermined for each field Fij of the mesh;
gradually shift the 3D model and the polygon mesh model into one another in a collision direction determined by the predetermined collision, in the virtual space, wherein an impression image having one or more impression pixels Pij is generated for each step k of the gradual shifting and a respective pixel value Pw of the one or more impression pixels Pij represents an impression depth of the 3D model in a field Fij of the mesh of the polygon mesh model that is assigned to the respective impression pixel Pij;
determining one or more respective stress values for the one or more impression pixels Pij of the impression image according to the stress-deformation characteristic curve assigned to the corresponding field Fij and the respective pixel value Pw; and
calculate a force F acting on the predetermined site on the body by adding up products of the stress values determined for the one or more impression pixels Pij with surface areas Aij of the assigned fields Fij of the mesh, for step k corresponding to impression image.
